(19) United States
(12) Patent Application Publication
(10) Pub. No.: US 2007/0168729 A1
(43) Pub. Date: Jul. 19, 2007

(54) System and method for testing and debugging electronic apparatus in single connection port

(75) Inventor: Cheng Che Chan, Banciao City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/294,836

(22) Filed: Dec. 6, 2005

(51) Int. Cl. G06F 11/00

(52) U.S. Cl. 714/30

(57) ABSTRACT

A method applied in a test host for testing and debugging an electronic apparatus is provided. The test host and the electronic apparatus are connected by a connection port. The method comprises the following steps. The method is started when the test host is at a command mode. The test host issuing a test command to the electronic apparatus. Then the test host receives a series of response signal corresponding to the test command during the electronic apparatus executing the test command. When the host detects the response signal representing an execution log, the test host is switched to a debugging mode to monitor the electronic apparatus executing the test command. When the test host extracts a test result from the response signal, the test host is switched to a command mode to receive the test result and issue another test command or stop the testing and debugging.

### BACKGROUND

The invention relates to testing and debugging an electronic apparatus, and more particularly, to system and method for testing and debugging an electronic apparatus in single connection port.

Electronic apparatuses such as optical disk drives, mobile phones, personal digital assistants (PDAs) or similar, are tested and debugged via a test host, i.e. a personal computer. The test host is typically equipped with two connection ports, one for issuing test commands and the other for debugging. For example, the test host may issue test commands to electronic apparatuses via a parallel port, and receive test results, error messages and execution logs via a serial port.

### SUMMARY

The objective of the present invention is to provide a method applied in a test host for testing and debugging an electronic apparatus with a single connection port. The test host and the electronic apparatus are connected by a connection port. The method comprises the following steps. The method is started when the test host is at a command mode. The test host issuing a test command to the electronic apparatus. Then the test host receives a series of response signal corresponding to the test command during the electronic apparatus executing the test command. When the host detects the response signal representing an execution log, the test host is switched to a debugging mode to monitor the electronic apparatus executing the test command. When the test host extracts a test result from the response signal, the test host is switched to a command mode to receive the test result and issue another test command or stop the testing and debugging.

The other objective of the present invention is to provide a system applied in a test host for testing and debugging an electronic apparatus. The system comprises a connection port, a state machine and a processing unit. The connection port is used for establishing a connection to the electronic apparatus. The state machine coupled to the connection port is used for controlling the test host to switch between a command mode and a debugging mode. The processing unit coupled to the state machine and the connection port is used for issuing test command and analyzing the corresponding received test result when the test host is in the command mode, and debugging the electronic apparatus by monitoring a plurality of received execution logs when the test host is in a debugging mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The invention will become more fully understood by referring to the following detailed description of embodiments with reference to the accompanying drawings, wherein:

FIG. 1 is a diagram of an embodiment of a testing and debugging system of a test host, and an electronic apparatus;

FIG. 2 is a diagram of an exemplary test message;

FIGS. 3a and 3b are diagrams of exemplary data organization of the response signal;

FIG. 4 is a diagram of the exemplary response signal;

FIG. 5 is a diagram of an embodiment of a test finite state machine (FSM); and

FIGS. 6a, 6b and 6c are flowcharts illustrating an embodiment of a method for testing and debugging electronic apparatuses.

### DESCRIPTION

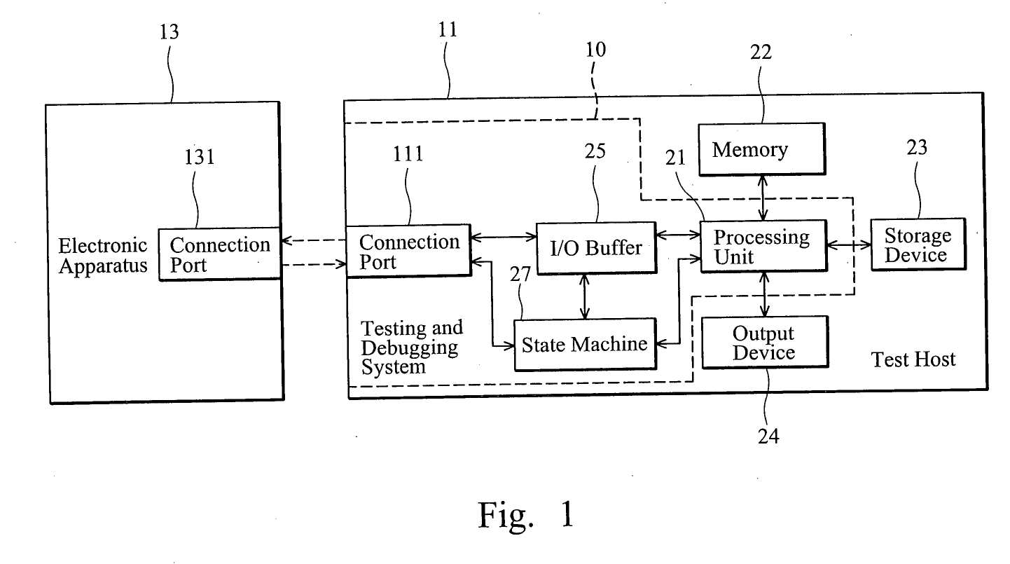

FIG. 1 is a diagram of an embodiment of a testing and debugging system 10 of a test host 11 according to the present invention, and an electronic apparatus 13.

The electronic apparatus 13 could be used in an automobile, plane, train, space vehicle, machine tool, camera, digital video recorder (DVR), consumer or office appliance, cell phone, PDA or other handheld as well as robot or toy, is tested and debugged by the test host 11. The electronic apparatus 13 is connected to the test host 11 by a connection port 131, and receives/responds signal from/to the test host 11 via the connection port 131.

The test host 11 issues test commands to the electronic apparatus 13, and receives execution logs and test results via a single connection port such as connection port 111. The connection port 111 may be a serial port, or a parallel port, etc. The serial port is such as a RS232, RS242, Universal Serial Bus (USB), IEEE 1394 port or similar. The parallel port is such as an Integrated Drive Electronics (IDE), Small Computer System Interface (SCSI), IEEE 1284 port or similar.

In one embodiment, the test commands are such as performing optimal power calibration (OPC), writing data, or reading data on an optical disk. In other embodiments, the test commands is depend on which kind of electronic apparatus being tested.

The test host 11 comprises the testing and debugging system 10, a memory 22, a storage device 23, and an output device 24. The testing and debugging system 10 comprises the connection port 111, a processing unit 21, an I/O buffer 25 and a state machine 27.

The processing unit 21 is coupled to the memory 22, the storage device 23, the output device 24 and state machine 27. There may be one or more processing units 21, such that the processor of the computer comprises a single central processing unit (CPU), a microprocessing unit (MPU) or multiple processing units, commonly referred to as a parallel processing environment.

The memory 22 is preferably a random access memory (RAM), but may also include read-only memory (ROM) or flash memory. The memory 22 preferably stores program modules executed by the processing unit 21 to perform electronic apparatus testing and debugging. Generally, program modules include routines, programs, objects, components, or others, that perform particular tasks or implement particular abstract data types. Moreover, those skilled in the art will understand that some embodiments may be practiced with other computer system configurations, including handheld devices, multiprocessor-based, microprocessor-based or programmable consumer electronics, network PCs, minicomputers, mainframe computers, and the like. Some embodiments may also be practiced in distributed computing environments where tasks are performed by remote processing devices linked through a communication network. In a distributed computing environment, program modules may be located in both local and remote memory storage devices based on various remote access architecture such as DCOM, CORBA, Web objects, Web Services or other similar architectures.

The storage device 23 may be a hard drive, magnetic drive, optical drive, portable drive, or nonvolatile memory drive. The drives and associated computer-readable media thereof (if required) provide nonvolatile storage of computer-readable instructions, data structures and program modules.

The state machine 27 is used to control the state of the test host switched between a command mode, a debugging mode and an error control mode. When the test host is in the command mode, the processing unit 21 acquires a test instruction in the test program and converts the acquired test instruction into a test command, typically a hardware instruction code recognized by the electronic apparatus 13.

The converted test commands are preferably compatible with a well-known Integrated Drive Electronics/AT Attachment Packet Interface (IDE/ATAPI) specification, especially when apply the present invention in the optical storage system. The processing unit 21 then issues a test message comprising the converted test command, a header comprising information regarding that the test message is provided by the test host 11, and a checksum. The checksum is utilized to ensure that the test message is transmitted without error.

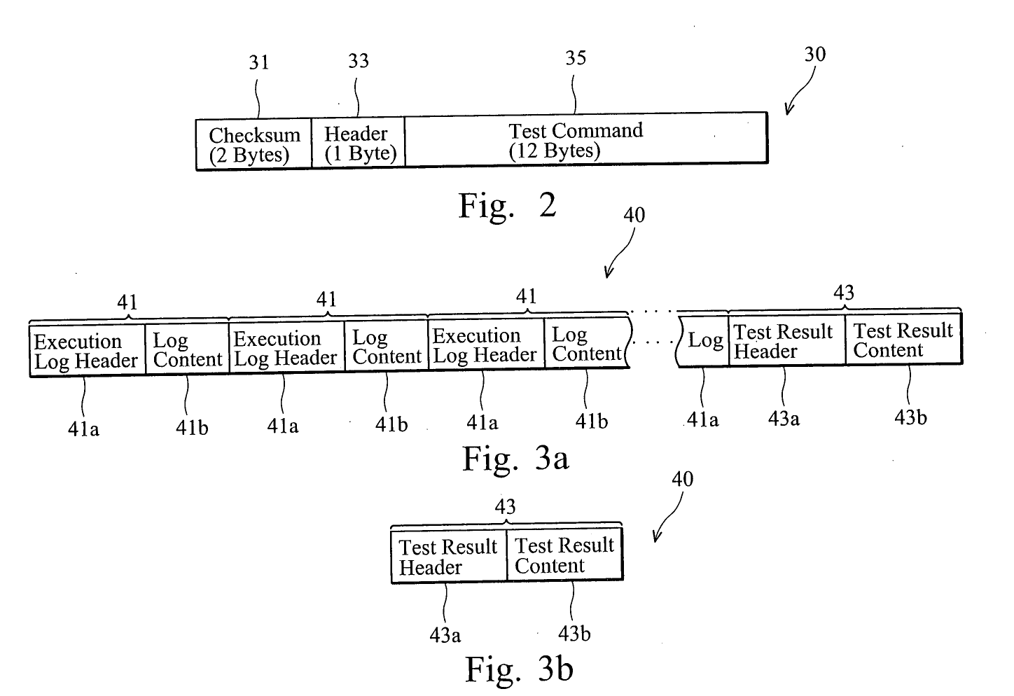

FIG. 2 is a diagram of an exemplary test message 30 comprising two bytes of checksum 31, one byte of header 33 and twelve bytes of test command 35. The processing unit 21 transmits the generated test message to the electronic apparatus 13 via the I/O buffer 25 and connection port 111. The electronic apparatus 13 then follows the order of the received test messages to execute the test commands therein.

A series of response signal containing execution logs and a test result corresponding to the transmitted test command are generated by the electronic apparatus 13 during execution of the test command. The responsed signals (maybe compiled in binary code) are subsequently received by the test host 11 via the connection port 111 and I/O buffer 25.

FIGS. 3a and 3b are diagrams of exemplary data organization of the response signal received by the test host 11. Referring to FIG. 3a, one or more execution logs 41 are generated during execution of a test command, respectively comprising an execution log header 41a and log content 41b, represented in binary code. Moreover, a test result 43 is generated after execution of a test command, comprising a test result header 43a and test result content 43b, represented in binary code. Referring to FIG. 3b, in this case, no execution log is generated during execution of a test command, and only a test result 43 is generated after execution of a test command. The lengths of both the execution log header 41a and the test result header 43a could be fixed, for example, one byte. The execution log header 41a contains a predefined number, such as one of ‘0×80’ to ‘0×8F’, representing a start point of an execution log. However, execution logs may be generated with the fixed or variable lengths. As lengths of execution logs are variable, the execution log header 41a further comprises information regarding the length of log content 41b. For example, a execution log ‘0×83’ indicates that the length of log content 41b is three bytes following the execution log header 41a. The test result header 43a, such as ‘0×0C’, representing a start point of a test result. The lengths of test result content 43b are typically varied by test commands, and are predetermined before transmission of test commands. The test result content 43b contains execution status regarding whether the execution of a test command is pass or fail. The test result content 43b may also contain response data when a test command has successfully executed, or one or more error messages when a test command fails to be executed.

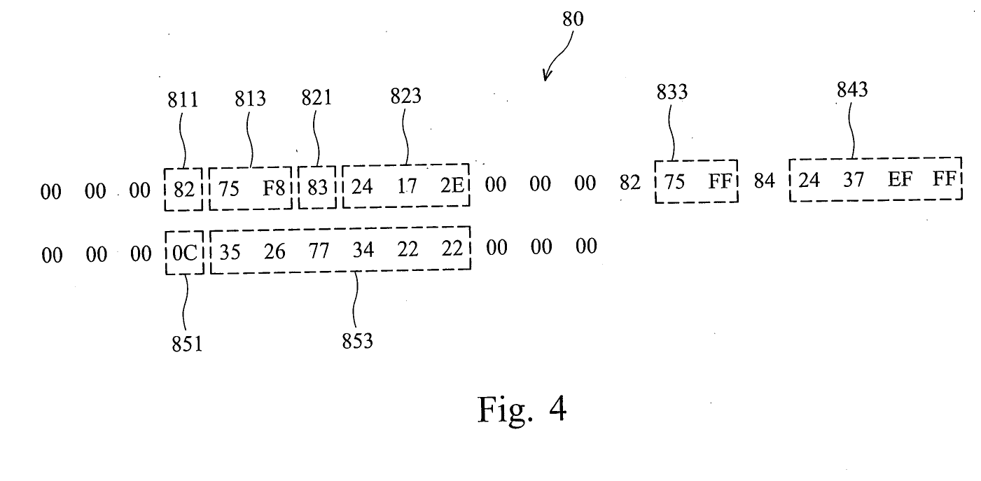

Details of the extraction of test result and execution logs of embodiment are illustrated in the following. FIG. 4 is a diagram of the exemplary response signal. Supposing that numbers ‘0×80’ to ‘0×8F’ are predefined to correspond to execution logs, a number ‘0×0C’ is predefined to correspond to a test result. Irrelevant code segments, such as “0×00 00 00” or some other undefined codes, are skipped.

The header 811 of the execution log “0×82”, which means the following two bytes “0×75 F8” are the content of an execution log 813. Thus, the header 821 of the execution log “0×83”, which means the following three bytes “0×24 17 2E” are the content of an execution log 823. Similarly, the content of two execution logs 833 and 843, “0×75 FF” and “0×24 37 EF FF” are belong to the header of “0×82” and “0×84”, respectively. Thereafter, the byte 851 “0×0C” corresponding to a test result is determined. Supposing that the length of test result content corresponding to a particular test command is six bytes, the content of a test result 853, “0×35 26 77 34 22 22”, is acquired.

Referring to FIG. 1, the processing unit 21 acquires a series of binary code from the I/O buffer 25, discovers predefined numbers therein to find out execution log and test result headers, such as 41a and 43a, and extracts log content and test result content, such as 41b and 43b.

During the extraction of execution logs and test results, the processing unit 21 repeatedly acquires a detection code segment from the response signal in the I/O buffer 25 until the I/O buffer 25 is empty or a test result is extracted. The processing unit examines if the detection code segment contains a predefined number corresponding to an execution log or a test result. If the detection code segment contains a predefined number corresponding to an execution log, the processing unit 21 acquires a log content segment of the given length from the response signal, as log content 41b. For example, supposing that the last four bits of an execution log header 41a indicates a log length (in bytes), when a detection code segment ‘0×83’ is acquired, the processing unit 21 acquires a log code segment of three bytes of the response signal, following the detection code segment.

The acquired log content 41b can further be translated into certain type of information, such as various types of log strings, recognized by an operator. The translated information corresponding to the acquired log content 41b may be stored in the memory 22 or the storage device 23 (as shown in FIG. 1) for further debugging, or may be displayed in a screen via the output device 24 (as shown in FIG. 1).

If the detection code segment contains a predefined number corresponding to a test result, the processing unit 21 may acquire a result code segment of the predetermined length from the response signal, as test result content 43b corresponding to the transmitted test command.

The processing unit 21 subsequently determines whether the execution of the transmitted test command is pass or fail by examining an execution status in the acquired test result content 43b. For example, the first byte of result content 43b may be used to represent an execution status, ‘0×00’ indicating that a test command has successfully executed, as well as, ‘0×01’ indicating that a test command fails to be executed. If the test command has successfully executed, the next test instruction in the test program is acquired for subsequent process. If the test command fails to be executed, an error control procedure may be performed. The error control procedure may retransmit the generated test message to the electronic apparatus 13. After one or more retransmissions fail to receive a test result indicating the execution of the test command therein is success, an error message is stored in the memory 22 or the storage device 23, or may be displayed in a screen via the output device 24.

If the detection code segment contains no predefined number for an execution log or a test result, a new detection code segment of the next byte from the response signal is subsequently acquired from the I/O buffer 25 and processed.

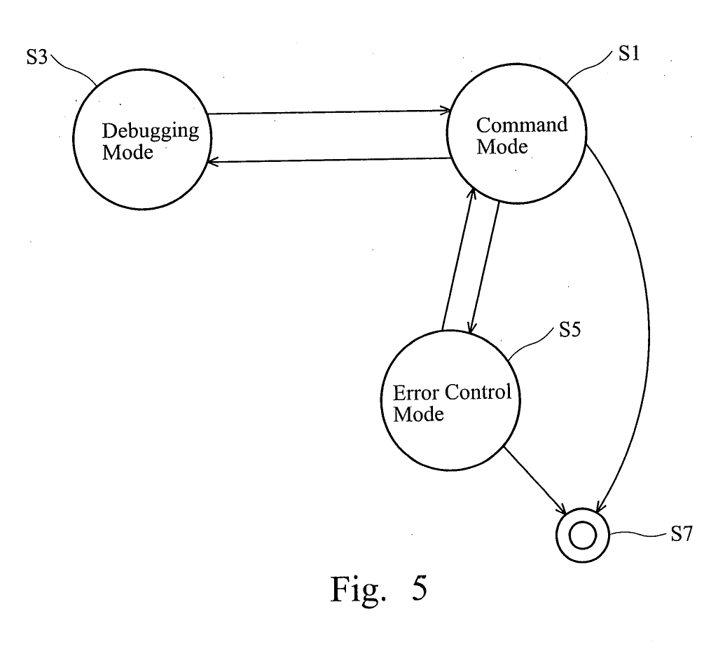

A test finite state machine (FSM) is written in program modules (i.e. firmware) or implemented in the state machine 27. FIG. 5 is a diagram of an embodiment of a test FSM, comprising four states such as command mode S1, debugging mode S3, error control mode S5, and halt state S7. The operation of test FSM will become more fully understood by referring to the following detailed description of embodiments of methods.

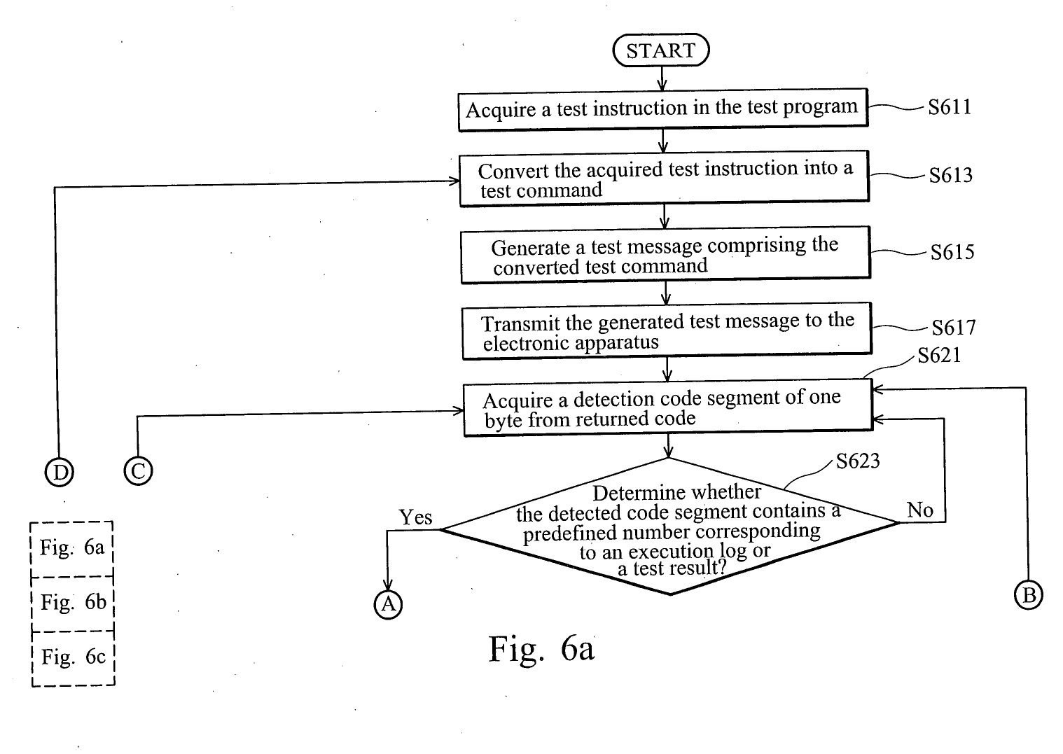

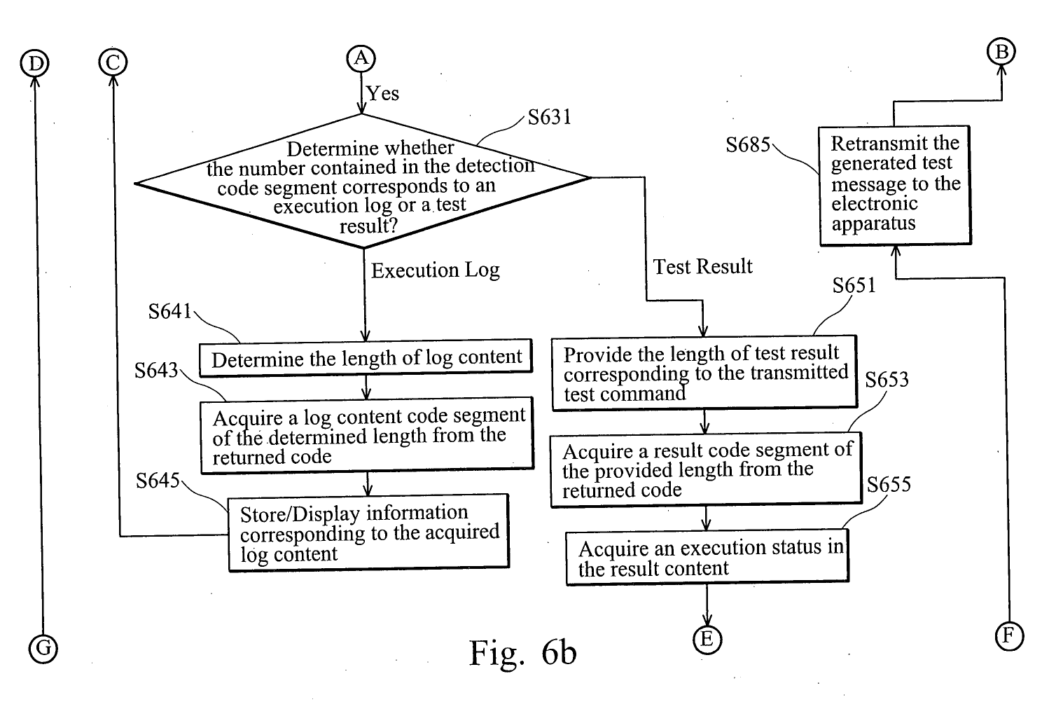

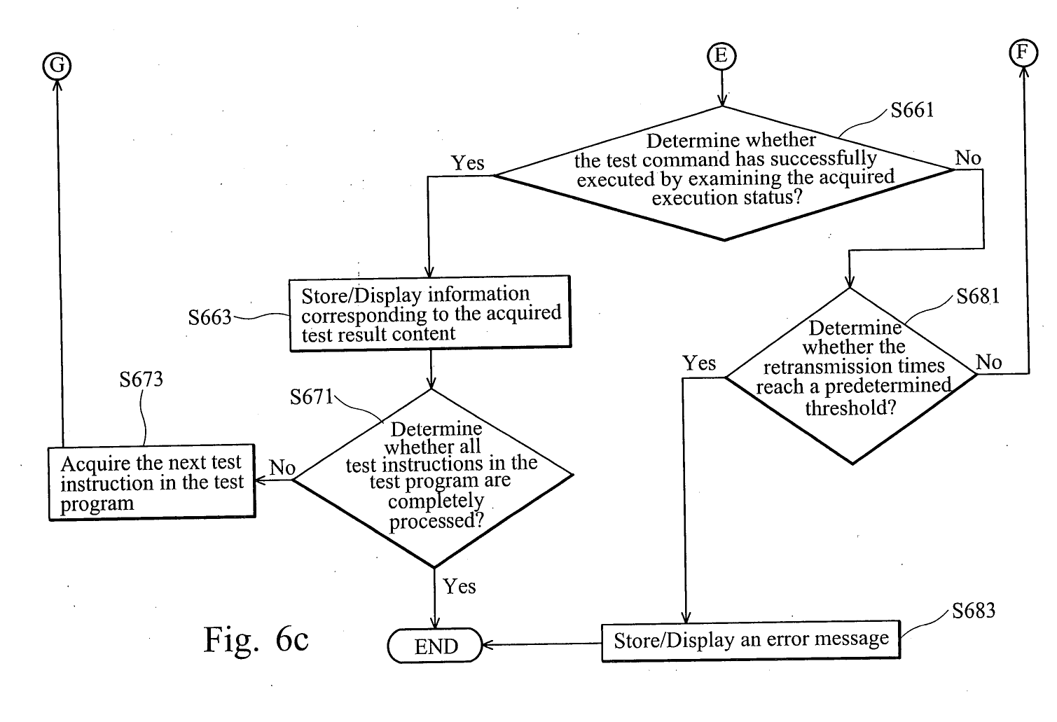

FIGS. 6a, 6b and 6c are flowcharts illustrating an embodiment of a method for electronic apparatus testing and debugging. An embodiment of a method is started in the command mode S1 (as shown in FIG. 5), and the command mode S1 contains actions including steps S611 to S617 and S673 (as shown in FIGS. 6a, 6b and 6c) to generate and transmit a test message for a test instruction, and receive a test result from the electronic apparatus 13. In step S611, a test instruction in the test program is acquired. In step S613, the acquired test instruction is converted into a test command, typically a hardware instruction code. In step S615, a test message is generated, comprising the converted test command, a header comprising information regarding that this test message comprises a test command to be executed, and a checksum, an exemplary test message as shown in FIG. 2. In step S617, the generated test message is transmitted to the electronic apparatus 13. Note that before or when the test message is transmitted, the length of the returned test result corresponding to the generated test command is predetermined.

In step S621, a detection code segment is acquired from response signal. Note that the response signal is preferably cached in the I/O buffer 25 (as shown in FIG. 1). In step S623, it is determined whether the detected code segment contains a predefined number corresponding to an execution log or a test result, and, if so, the process proceeds to step S631, and otherwise, returns to step S621. Steps S621 and S623 may be repeatedly performed to skip irrelevant code segments.

In step S631, it is determined whether the number contained in the detection code segment corresponds to an execution log or a test result, and, if the number corresponds to an execution log, the process proceeds to step S641, and otherwise, to step S651. Note that when a predefined number corresponding to an execution log is detected during the command mode S1, the FSM transits the command mode S1 to a debugging mode S3 (as shown in FIG. 5). The debugging mode S3 contains actions including steps S631 to S645. In step S641, the length of log content is determined. As all execution logs are generated with a given length, a log content segment of the given length is acquired from the response signal. Alternatively, as lengths of execution logs are variable, a log length is acquired from the detection code segment. In step 645, information corresponding to the acquired log content is stored in the memory 22 or storage device 23 (as shown in FIG. 1), or displayed on a screen via the output device 24 (as shown in FIG. 1). In this step, the acquired log content 41b can further be translated into certain types of information, such as log strings, recognized by an operator.

In step S651, the length of test result corresponding to the transmitted test command is provided. Note that when a predefined number corresponding to a test result is detected during the debugging mode S3, the FSM transits the debugging mode S3 to a command mode S1 (as shown in FIG. 5). In step S653, a result code segment of the provided length is acquired from the response signal, as test result content 43b (as shown in FIG. 3a or 3b). In step S655, an execution status in the result content 43b is acquired. In step S661, it is determined whether the test command has successfully executed by examining the acquired execution status, and, if so, the process proceeds to step S663, and otherwise, to step S681. When the test command fails to execute, the FSM transits the command mode S1 to an error control mode S5 (as shown in FIG. 4).

In step S663, information corresponding to the acquired test result content is stored in the memory 22 or storage device 23 (as shown in FIG. 1), or displayed on a screen via the output device 24 (as shown in FIG. 1). In this step, the acquired test result content 43b can further be translated into certain types of information, such as result messages, execution reports, return data table or similar, recognized by an operator.

In step S671, it is determined whether all test instructions in the test program are completely processed, and, if so, the entire process ends, and otherwise, the process proceeds to step S673. When all test instructions are completely processed, the test FSM transits the command mode S1 to the halt state S7 (as shown in FIG. 4). When all test instructions are not completely processed, the next test instruction in the test program is acquired.

In step S681, it is determined whether the retransmission times reach a predetermined threshold, and, if so, the process proceeds to step S683, and otherwise, to step S685. In step S683, an error message is stored in the memory 22 or storage device 23 (as shown in FIG. 1), or displayed on a screen via the output device 24 (as shown in FIG. 1). When the retransmission times do not reach the predetermined threshold, the FSM transits the error control mode S5 to the command mode S1 (as shown in FIG. 4) to retransmit the generated test message. When the retransmission times reach the predetermined threshold, the FSM transits the error control mode S5 to the halt state S7 (as shown in FIG. 4). In step S685, the generated test message is retransmitted to the electronic apparatus 13 (as shown in FIG. 1), thereby directing the electronic apparatus 13 to perform the same test command again. Test messages and the response signal are preferably transmitted and received by a single connection port, such as connection port 111 (as shown in FIG. 1).

The System and method, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer system, mobile station, projector, displayer, mp3 player and the like, the machine becomes an apparatus for practicing the invention. The disclosed methods and apparatuses may also be embodied in the form of program code transmitted over some transmission medium, such as electrical wiring or cabling, through fiber optics, or via any other form of transmission, wherein, when the program code is received and loaded into and executed by a machine, such as a computer or an optical storage device, the machine becomes an apparatus for practicing the invention. When implemented on a general-purpose processor, the program code combines with the processor to provide a unique apparatus that operates analogously to specific logic circuits.

Certain terms are used throughout the description and claims to refer to particular system components. As one skilled in the art will appreciate, consumer electronic equipment manufacturers may refer to a component by different names. This document does not intend to distinguish between components that differ in name but not function.

Although the invention has been described in terms of preferred embodiment, it is not limited thereto. Those skilled in this technology can make various alterations and modifications without departing from the scope and spirit of the invention. Therefore, the scope of the invention shall be defined and protected by the following claims and their equivalents.

What is claimed is:

1. A method applied in a test host for testing and debugging an electronic apparatus, the test host and the electronic apparatus being connected by a connection port, the method comprising:
starting at a command mode;
issuing a test command to the electronic apparatus;
receiving a series of response signal corresponding to the test command during the execution of the test command by the electronic apparatus;
when detecting the response signal representing an execution log, switching to a debugging mode to monitor the electronic apparatus executing the test command; and
when extracting a test result from the response signal, switching to a command mode to receive the test result and issue another test command or stop the testing and debugging.

2. The method of claim 1, wherein the response signal comprises a plurality of sets of headers and data, each header corresponds to a length of data.

3. The method of claim 2, wherein the detecting step further comprises:
when detecting a header of the response signal represented that the length of data corresponding to the header is the execution log, switching to the debugging mode.

4. The method of claim 2, wherein the extracting step further comprises:
when detecting a header of the response signal represented that the length of data corresponding to the header is the test result, switching to the command mode.

5. The method of claim 2 wherein the extracting step further comprises:
detecting a header of the test result from the response signal; and
acquiring a length of data corresponding to the header and determining the length of data to be the test result corresponding to the test command.

6. A system applied in a test host for testing and debugging an electronic apparatus, comprising:
a connection port for establishing a connection with the electronic apparatus; and
a state machine coupled to the connection port, for controlling the test host to switch between a command mode and a debugging mode; and
a processing unit coupled to the state machine and the connection port for issuing a plurality of test command and analyzing a plurality of received test result when the test host is in the command mode, and debugging the electronic apparatus by monitoring a plurality of received execution logs when the test host is in a debugging mode.

7. The system of claim 6, wherein when the state machine detects a response signal representing an execution log, the state machine switches the test host to a debugging mode, the response signal is responded from the electronic apparatus after the test host issuing a test command to the electronic apparatus.

8. The system of claim 7, wherein when the state machine detects a response signal representing a test result, the state machine switches the test host to a command mode, the response signal is responded from the electronic apparatus after the test host issuing a test command to the electronic apparatus.

9. The system of claim 8, wherein the response signal comprises a plurality of sets of headers and data, each header corresponds to a length of data.

10. The system of claim 8, wherein when the state machine detects a header of the response signal represented that the length of data corresponding to the header is the execution log, the state machine switches to the debugging mode.

11. The system of claim 8, wherein when the state machine detects a header of the response signal represented that the length of data corresponding to the header is the test result, switching to the command mode.

12. The system of claim 8, wherein when the state machine detects a header of the test result, the processing unit acquires a length of data corresponding to the header and determining the length of data to be the test result corresponding to the test command.
